(19) United States
(12) Patent Application Publication
(10) Pub. No.: US 2026/0004799 A1
(43) Pub. Date: Jan. 1, 2026

(54) PLATFORM FOR DEAF AND HEARING-IMPAIRED INDIVIDUALS

(71) Applicant: Kokomo Solutions, Inc., Northbrook, IL (US)

(72) Inventor: Daniel Jongdae Lee, Northbrook, IL (US)

(21) Appl. No.: 19/248,877

(22) Filed: Jun. 25, 2025

Related U.S. Application Data
(60) Provisional application No. 63/664,579, filed on Jun. 26, 2024.

(51) Int. Cl. G10L 21/06

(52) U.S. Cl. CPC G10L 21/06

(57) ABSTRACT

A cloud-based platform for use in communicating with deaf or hearing-impaired individuals and a method of using the cloud-based platform. This platform includes a cloud-based server having memory and at least one processor; a software system having a flexible architecture configured to interact with a user, a plurality of information management modules, and one or more communication devices; and a user interface. The memory of the cloud-based server stores data and instructions received directly from the user and/or the information management modules. The stored data is provided to the deaf or hearing-impaired individuals through the one or more communication devices upon the at least one processor executing the stored instructions. The user may be a safety officer, a nurse, a teacher, a principal, or another staff member of a school or an employee of an authorized vendor or contractor.

### CROSS REFERENCE TO RELATED APPLICATIONS

This application claims the benefit of the filing date under 35 U.S.C. § 119(e) of U.S. Provisional Application No. 63/664,579 filed on June 26, 2024, the entire contents of which is incorporated herein by reference.

### FIELD

The present invention relates to informational platforms for deaf and hearing- impaired individuals. More specifically, the invention relates to platforms that provide information and/or services to individuals that are "hard-of-hearing" in school and at work or public facilities.

### BACKGROUND

The statements in this section merely provide background information related to the present disclosure, as well as definitions of terms used in the present disclosure and may not constitute prior art.

According to the World Health Organization (WHO), over five percent of the world's population (e.g., -430 million people), including approximately 34 million children, require rehabilitation to address disabling hearing loss. WHO estimates that by 2050 over 700 million people-or one in every ten people-will experience disabling hearing loss. Disabling hearing loss refers to a loss in hearing that is greater than 35 decibels (dB) in both ears of an individual. The prevalence of hearing loss typically increases with age and among those older than 60 years over 25% are affected by disabling hearing loss.

A person who is not able to hear as well as someone with normal hearing - i.e., hearing thresholds of 20 dB or better in both ears - is said to have hearing loss. Hearing loss may be mild, moderate, severe, or profound. Hearing loss can affect one ear or both ears of an individual and generally leads to difficulty in hearing conversational speech and/or loud sounds.

"Hard of hearing" refers to people with a hearing loss that ranges from mild to severe. People who are hard of hearing usually communicate through spoken language and can benefit from hearing aids, cochlear implants, and other assistive devices, such as those that include captioning. A "deaf' person generally suffers from profound hearing loss, which implies very little to no hearing. A deaf person will often use sign language for communication. In both cases (hard of hearing or deaf), assistive technology is extremely useful as a learning and teaching tool.

When parents begin searching for the right school for a deaf or hearing- impaired child, many significant differences may be found to exist between schools. These differences range from different overall strategies for teaching children to the different programs available that target one or more specific needs of the students. Schools often vary in terms of the services and resources offered, such as the level of deaf assistive technology provided, which is a key consideration for any parent selecting a school for a deaf or hearing-impaired child.

However, assistive technology for use by a school for their students, particularly for a deaf and/or hearing-impaired student, is expensive and often becomes outdated very quickly. For example, the Marlton School located in the Los Angeles Unified School District (LAUSD), which is a dedicated school for deaf and hard of hearing students, has over 100 conventional Video Emergency Notification (VEN) stations throughout the facility. Each of these VEN stations 5 as shown in generally consists of several basic devices, such as stoke or strobe lights 7, a message display (carousel) 10, a television set 13, and an interactive experience client (IEC) 15. The IEC 15 provides a basic connection to a high-definition display, e.g., TV 13. The IEC 15 includes a web browser that supports a variety of content including localized information, the display of existing web portals, advertising, and American Sign Language (ASL) video clips. An ASL video clip generally features a person signing using ASL, typically to convey a message or provide information. This type of conventional VEN station 5, which was available for installation greater than five years ago at a substantially high cost, is now considered by industry standards as being antiquated.

Thus, there is a need to replace the antiquated VEN systems that are currently in use with a flexible platform that represents a niche turn-key solution for any and all hearing-impaired communities, e.g., schools, workplaces, and public venues, such as stores, restaurants, and the like. The development of a single platform that combines multiple functions and specialty services aimed at educational use, workplace use, public/convention use, and/or event use, as well as provide flexibility for future integration with additional systems would provide a substantial improvement and upgrade over existing technology.

### SUMMARY

An objective of the present disclosure is to provide an improved informational platform and system for use with deaf and hearing-impaired individuals that overcome the limitations of prior technology and performs multiple functions with associated devices without sacrificing design, style, or affordability. The platform is cloud-based and provides numerous devices for providing information to deaf and hard of hearing individuals (collectively "hearing-impaired") in a work, learning, or recreational environment.

According to one aspect of the present disclosure, the cloud-based platform for use in communicating with deaf or hearing-impaired individuals generally comprises: a cloud-based server having memory and at least one processor; a software system having a flexible architecture configured to interact with a user, a plurality of information management modules, and one or more communication devices; and a user interface. The memory of the cloud-based server stores data and instructions received directly from the user and/or the information management modules. The stored data is provided to the deaf or hearing-impaired individuals through the one or more communication devices upon the at least one processor executing the stored instructions. The user may be a safety officer, a nurse, a teacher, a principal, or another staff member of a school or an employee of an authorized vendor or contractor.

The one or more communication devices may include at least one wall unit, classroom unit, or advanced network device (AND) for use in a building or a confined area. The wall unit, classroom unit, or AND may comprise stoke or strobe lights and/or a display unit configured to exhibit one or more of emergency signage, general messages, and American Sign Language (ASL) videos. The one or more communication devices may further comprise at least one mobile device, such as, without limitation, a cell phone, a personal digital assistant (PDA), or a tablet personal computer. The display unit generally comprises a message board, a scrolling message board, or a television screen.

The cloud-based server may be coupled to a telephone or internet system, such that the one or more communication devices allow for two-way communication between the deaf or hearing-impaired individuals and the user and/or the information management modules.

The information management modules may comprise a content management module, and ads management module, and a device management module. The content management module integrates a learning management system and a student information system with an identity management framework. The ads management module is connected with one or more broadcast networks. The device management module includes an emergency notification/alert system. When desirable, the information management modules may further comprise one or more of a telehealth or telemedicine module, a safety or wellness module, a visitor or guest management module, an incident or compliance management module, a ticketing or event management module, a tip-line module, a panic button module, an artificial intelligence (AI) predictive analysis module, and a communications suite module.

The communications suite module comprises an assistive communication system configured to translate spoken language or interpret and convert sign language motions into text shown on the one or more communication devices. The communications suite module may also provide for communication between the deaf or hearing-impaired individuals and a sign language interpreter. In general, the communications suite module provides for communication using American Sign Language (ASL) and other sign languages.

The telehealth or telemedicine module is configured to allow communication between the deaf or hearing-impaired individuals and a medical professional, while the panic button module is configured to allow the deaf or hearing-impaired individuals to activate and send an alert to emergency personnel with GPS tracking of the communication device being enabled.

According to another aspect of the present disclosure, a method for communicating information to deaf or hearing-impaired individuals is provided. This method generally comprises the steps of: providing the cloud-based platform as described above and as further defined herein; allowing the user to input and store data and/or an instruction into the memory of the cloud-based server; the data and/or instruction being relative to one or more of the information management modules; allowing the processor to access the memory and perform the instruction that has been input by the user; and communicating the data according to the instruction to the deaf or hearing-impaired individuals via one or more of the communication devices.

The data is communicated to the deaf or hearing-impaired individuals by exhibiting one or more of an emergency signage, general message, or American Sign Language (ASL) video to at least one of a wall unit, a classroom unit, a mobile device, or an advanced network device (AND). The communication of the data may involve two- way communication between the deaf and hearing-impaired individuals and at least one other person. This two-way communication of the data may include access to and connection with an assistive communication system that translates spoken language into text or sign language and/or interprets and converts sign language motions into text. The two-way communication of the data may also include communication between the deaf or hearing-impaired individuals and a sign language interpreter. Finally, the two-way communication of the data may occur between the deaf or hearing-impaired individuals and a medical professional or emergency response personnel.

Further areas of applicability will become apparent from the description provided herein. It should be understood that the description and specific examples are intended for purposes of illustration only and are not intended to limit the scope of the present disclosure.

### DESCRIPTION OF THE DRAWINGS

In order that the disclosure may be well understood, there will now be described various forms thereof, given by way of example, reference being made to the accompanying drawings. The components in each of the drawings may not necessarily be drawn to scale, but rather emphasis is placed upon illustrating the principles of the invention.

FIG. 1 is a schematic depiction of a conventional Video Emergency Notification (VEN) station.

FIG. 2 is a schematic depiction of a cloud-based platform for deaf and hearing- impaired individuals formed according to the teachings of the present disclosure.

FIG. 3A is a schematic depiction of the information management modules located in the cloud-based platform of .

FIG. 3B is a schematic depiction that further describes the information management modules of FIG. 3A.

FIG. 4 is a schematic depiction of additional information management modules that may be incorporated into the cloud-based platform of FIG. 2.

Fig. 5 is a flow diagram that describes the workflow for a telehealth module according to one aspect of the cloud-based platform of Fig.2.

Fig. 6 is a flow diagram that describes the workflow for a panic button module available as one of the information management modules associated with the cloud-based platform of FIG. 2.

FIG. 7 is a flowchart describing a method for communicating information to deaf or hearing-impaired individuals using the cloud-based platform of FIG. 2.

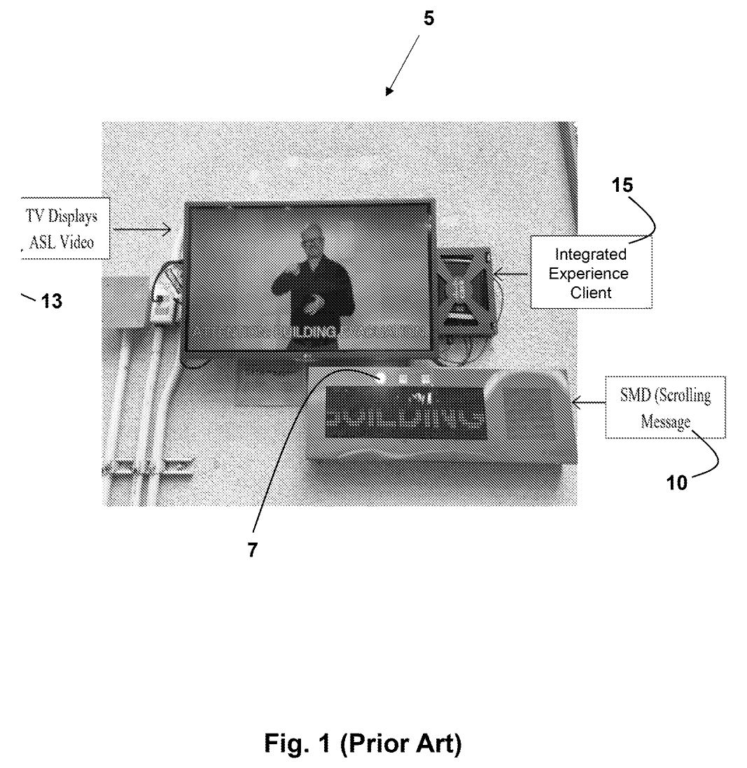

The drawings described herein are for illustration purposes only and are not intended to limit the scope of the present disclosure in any way. It should be understood that throughout the description and drawings, corresponding reference numerals indicate like or corresponding parts and features.

### DETAILED DESCRIPTION

The following description is merely exemplary in nature and is in no way intended to limit the present disclosure or its application or uses. For example, the cloud- based platform as formed and used according to the teachings contained herein is described throughout the present disclosure in conjunction with a school environment or building for the deaf and hearing-impaired in order to more fully illustrate the elements and the use thereof. The incorporation and use of such a cloud-based platform in other environments or facilities, such as public buildings, office buildings, work facilities, as well as open air venues such as stadiums, parks, and the like, is contemplated to be within the scope of the present disclosure.

For the purpose of this disclosure, the terms "about" and "substantially" are used herein with respect to measurable values and ranges due to expected variations known to those skilled in the art (e.g., limitations and variability in measurements).

For the purpose of this disclosure, the terms "at least one" and "one or more of" an element are used interchangeably and may have the same meaning. These terms, which refer to the inclusion of a single element or a plurality of the elements, may also be represented by the suffix "(s)" at the end of the element. For example, "at least one module", "one or more modules", and "module(s)" may be used interchangeably and are intended to have the same meaning.

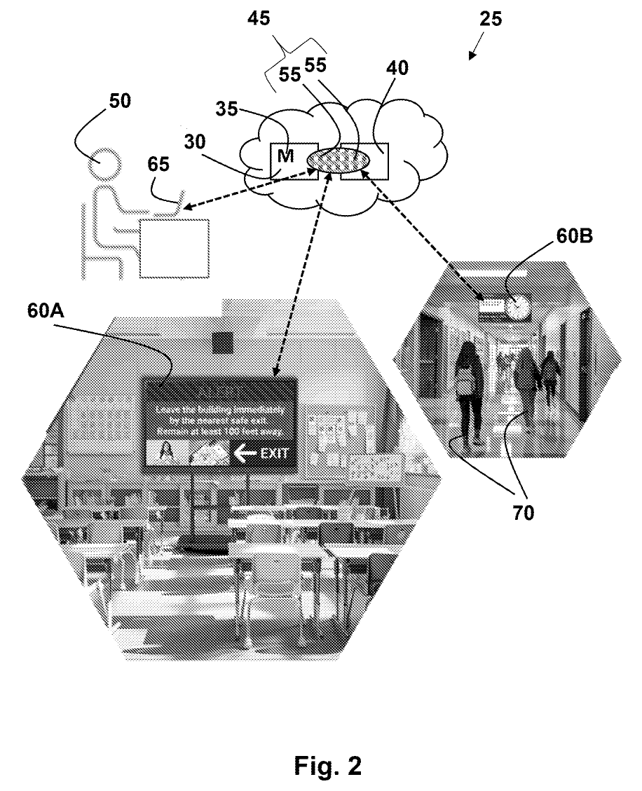

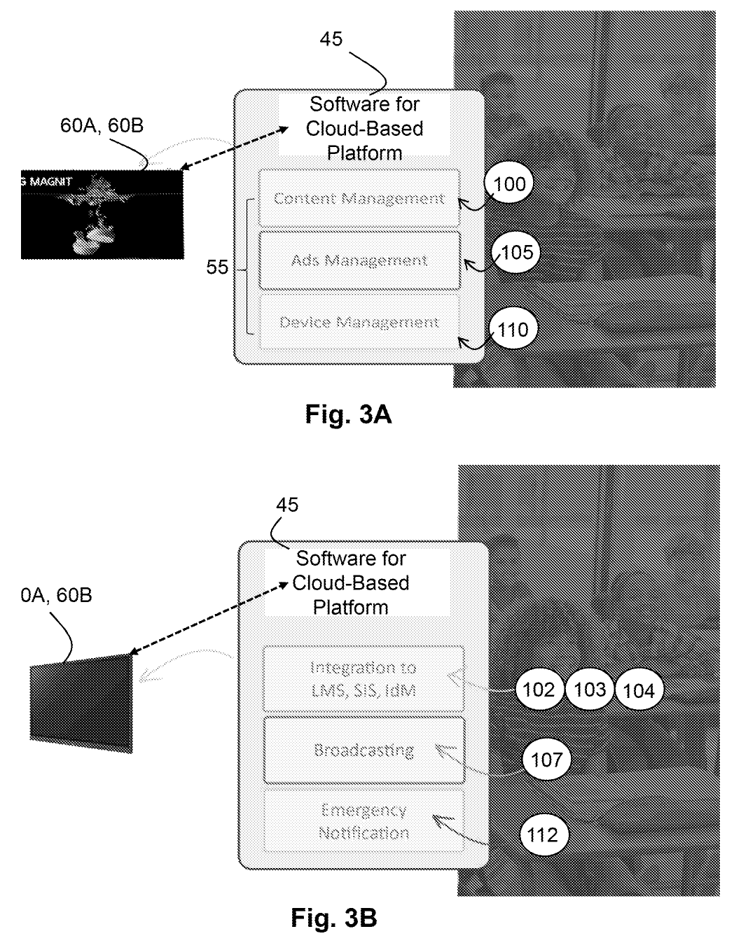

The present disclosure generally provides a cloud-based platform for use in communicating with deaf or hearing-impaired individuals. Referring now to FIG. 2, this cloud-based platform 25 comprises a cloud-based server 30 having memory 35 and at least one processor 40; a software system 45 having a flexible architecture configured to interact with a user 50, a plurality of information management modules 55, and one or more communication devices 60A, 60B; and a user interface 65. The memory 35 of the cloud-based server 30 stores data and instructions received directly from the user 50 and/or the information management modules 55. This stored data is then provided to the deaf or hearing-impaired individuals 70 through the one or more communication devices 60A, 60B upon the at least one processor 40 executing the stored instructions. The user 50 may be a safety officer, a nurse, a teacher, a principal, or another staff member of a school or an employee of an authorized vendor or contractor.

The cloud-based platform of the present disclosure provides the deaf and hearing-impaired individuals with a turn-key or total solution that improves the safety of the individual, enhances facility management, and ensures compliance with industry standards in being equipped with the hardware and software configured to meet the needs of the deaf and hearing-impaired in communicating with a third party, as well as delivering the requested service(s). The cloud-based platform enhances engagement between the deaf and hearing individuals, as well as increases the communication of knowledge and necessary emergency and general information in addition to streamlining administrative tasks. This platform facilitates better decision-making by providing a unified view of student information with enhanced data accuracy.

Referring now to Fig.'s 3A and 3B, the information management modules interfaced with the software system in the cloud-based platform may comprise a content management module 100, and ads management module 105, and a device management module 110. The content management module 100 integrates a learning management system 102 and a student information system 103 with an identity management framework 104. The ads management module 105 is connected with one or more broadcast networks 107. The device management module 110 includes an emergency notification/alert system 112.

The learning management system (LMS) 102 represents software that is configured to plan, create, deliver, manage, and/or track educational and training courses or programs. This system 102 actively enhances engagement and knowledge retention, improves compliance training, facilitates remote learning, and organizes administrative tasks. In other words, the LMS 102 is used to deliver educational content and track the progress of students in a course.

The student information system (SIS) 103 is software that serves as a central database for student-related information and administrative data. The SIS 103 is generally used to manage student enrollment, attendance, grades, and disciplinary actions relative to the school and/or specific educational programs.

The identity management (IdM) framework 104 represents a process configured to manage the identity and privileges associated with an individual's access to specific student or course data. The functionality of this framework 104 generally includes registration, authentication, and access control parameters in order to ensure that only authorized individuals can gain access to the LMS 102 and SIS 103 systems, thereby, ensuring that student information is securely protected and the integrity of the data is maintained.

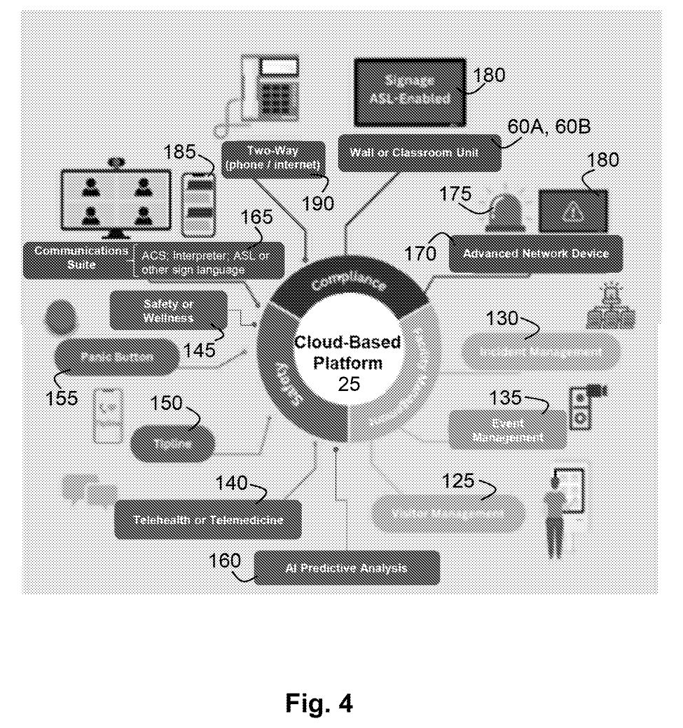

According to another aspect of the present disclosure, the cloud-based platform may comprise one or more additional informational management modules. Alternatively, the cloud-based platform comprises at least two additional management modules; alternatively, three or more additional management modules. Referring now to FIG. 4, these additional information management modules may be, without limitation, related to the areas of safety, facility management, or compliance. For example, several information management modules related to facility management may include a visitor or guest management module 125, an incident or compliance management module 130, a ticketing or event management module 135. Several examples of information management modules related to safety include, but are not limited to a telehealth or telemedicine module 140, a safety or wellness module 145, a tip-line module 150 to provide anonymous reporting of non-emergency incidents, a panic button module 155 to activate an alert for assistance in an emergency, and an artificial intelligence (AI) predictive analysis module 160 with machine learning configured to find trends between incident reports and to model the likelihood of future incidents. A specific example of a compliance related information management module includes, without limitation, a communications suite module 165.

The artificial intelligence (AI) predictive analysis module 160 may include a variety of analytics tools configured to anticipate or determine what metrics are most important and ranking such metrics appropriately. This module 160 may further comprise task or workflow tools that understand what work needs to be done and prioritizes the work accordingly. A situational awareness function is capable of recognizing what information is most important, while a record management function identifies trends that may exist between various data points. Finally, the module 160 may also include compliance tools and notification tools that recognizes and proceeds to complete the necessary reports and/or automatically provides the necessary communication functions.

The communications suite module 165 may include a variety of functionality as found necessary or desirable. For example, according to one aspect of the present disclosure, the communications suite module 165 may comprise an assistive communication system (ACS) configured to translate spoken language or interpret and convert sign language gestures into text shown on the one or more communication devices. The communications suite module may also provide for communication between the deaf or hearing-impaired individuals and a sign language interpreter. The communications suite module may further provide for communication using American Sign Language (ASL) and other sign languages.

According to another aspect of the present disclosure, additional compliance related information management modules may generally be related to the software that interacts with the communication devices associated with the cloud-based platform 25. Referring again to both Fig.'s 2 and 4, the one or more communication devices may include at least one wall unit 60B, a classroom unit 60A or kiosk, or an advanced network device (AND) 170 for use in a building or a confined area. These communication devices may comprise stoke or strobe lights 175 and/or a display unit 180 configured to digitally exhibit a clock and one or more of emergency signage, general messages or announcements, and American Sign Language (ASL) videos and messaging. The stoke or strobe lights 175 may include any color, including without limitation, red, green, yellow, white, and blue. When desirable or necessary the one or more communication devices may further comprise at least one mobile device 185, such as, without limitation, a cell phone, a personal digital assistant (PDA), or a tablet personal computer. The display unit 180 may comprise a message board, a scrolling message board, or a television screen.

The advanced network device (AND) 170 along with additional support from the communication suite module 165 and the two-way communication system 190 may provide captioned telephone services (CTS). An example of such a service includes the use of the internet and artificial intelligence (AI) software to convert either text-to-speech or speech-to-text in real time. More specifically, this type of assistive communication system, e.g., "Internet of Things" (loT) system, coupled with artificial intelligence and/ormachine learning software are capable of interpreting and converting sign language into text or voice, thereby, allowing deaf or hearing-impaired individuals to communicate with people whom do not understand sign language. This type of service also allows deaf and hearing-impaired individuals to read what is being said to them during the conversation.

According to another aspect of the present disclosure, the cloud-based server may be coupled to a telephone or internet system 190, such that the one or more communication devices allow for two-way communication between the deaf or hearing- impaired individuals and the user and/or the information management modules. This two- way communication 190 along with additional support from the communication suite module 165 may include a video relay service (VRS) device that leverages the internet (broadband) to enable communication with deaf or hearing-impaired individuals that require the use of American Sign Language (ASL). The VRS generally includes a video device connected to the internet that enables the deaf or hearing-impaired individuals to communicate in sign language with a sign language interpreter that subsequently relays the conversation verbally or in text to the necessary party via a standard telephone or internet set-up.

Additional or specific details relative to some of the information management modules are found in co-pending patent applications. For example, further details relative to an incident management module 130 may be found in co-pending U.S. patent application No. 17/658,890 filed April 12, 2022, the entire content of which is hereby incorporated by reference. Further details relative to a safety and wellness module 145 may be found in co-pending U.S. patent application No. 19/175,953 filed April 10, 2025, the entire content of which is hereby incorporated by reference.

The Telehealth or Telemedicine information management module 140 generally allows the deaf or hearing-impaired individual within the school or business to obtain primary health care, behavioral health care, and/or mental health care. This module requires the consent of the individual or if a minor the consent of the parent(s) to allow a nurse or other on-site health professional to contact a physician or other medical professional via the two-way communication (e.g., internet) module 190 or using another method found within the communications suite module 165 in order to provide the necessary medical attention or treatment for the deaf or hearing-impaired individuals.

Addressing student health and wellbeing is of paramount importance for most school systems. In this respect, the return to class rate (RTC) after telehealth care services are rendered is considerably higher than the RTC arising from a visit to an on- site nurse for medical attention. In fact, the RTC for telehealth services is about 85.0% compared to only 51.3% for nurse visits. The ability to obtain virtual care offers the school system many benefits, such as, for example, improving student health, enhanced wellness, and both physical and mental wellbeing, securing cost effective health services for students of all socioeconomic need, reducing school absenteeism and early departure from school for illness or injury, and promoting access to services with integrated translation or interpretation services (including ASL) and teleconferencing capability for parent or guardian participation.

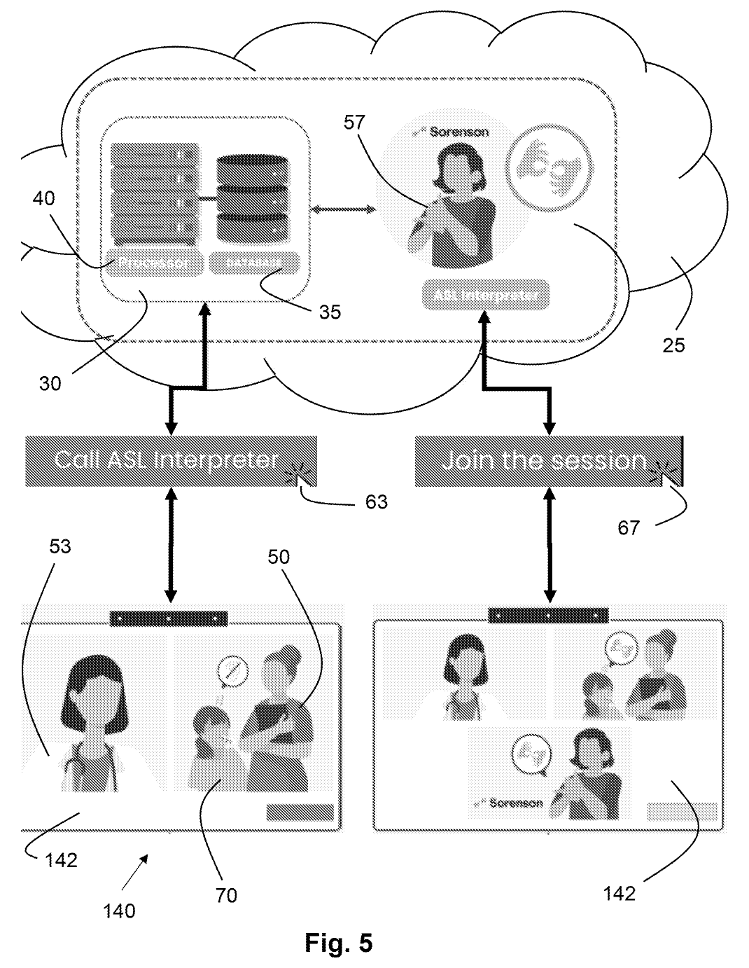

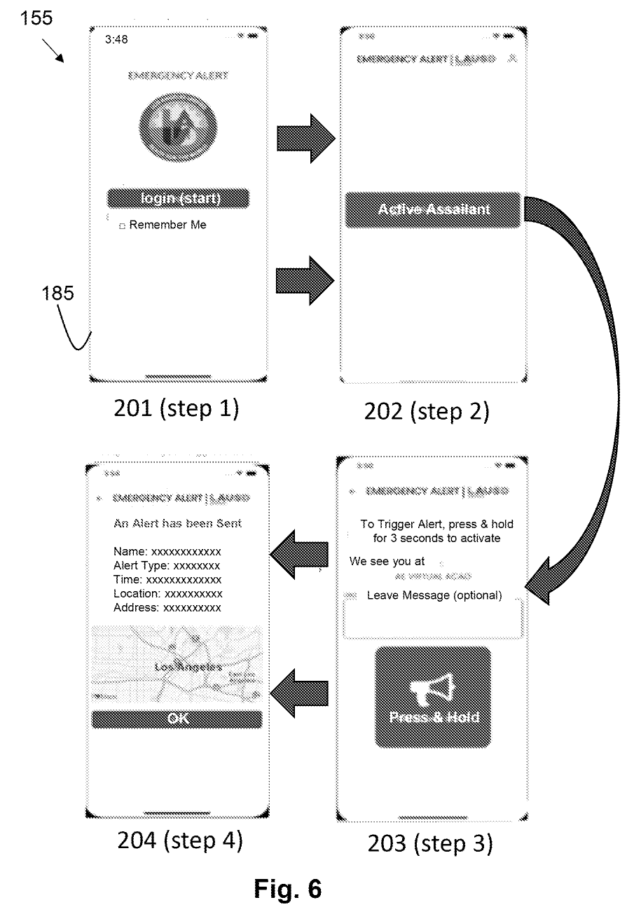

Referring now to FIG. 5 , according to one aspect of the present disclosure, the Telehealth or Telemedicine information management module 140 may involve a deaf or hearing-impaired individual 70 meeting with a school nurse 50 due to an illness or injury. The school nurse 50 may initiate a telehealth session 142 with a physician 53. In order to more precisely communicate with the deaf or hearing-impaired individual 70, the school nurse 50 or physician 53 may press a "call ASL interpreter" button 63, which immediately sends a request or instruction to the cloud-based server 30 associated with the cloud- based platform 25. The processor 40 of the cloud-based server 30 performs the instruction by assigning an ASL interpreter 57 from the accessed memory 36, e.g., stored in a database. The ASL interpreter 57 is contacted and then connected to the Telehealth session 142 by pressing the "join the session" button 67.

The panic button module 155, which can be accessed via any classroom unit, wall unit, AND, kiosk, or mobile device provides the deaf and hearing-impaired individuals with the ability to activate and send an alert to emergency personnel with GPS tracking of the communication device being enabled. The emergency personnel may include, without limitation, medical personnel, school administration, and/or law enforcement. Alternatively, the panic button module may be accessed by a unit that is wearable, such as a necklace, bracelet/watch, or clipped to a belt. Referring now to , the workflow associated with the panic button module 155 used with a mobile device 185 generally comprises the steps of: 1) login or starting 201 the module 155; 2) automatic activation of the panic button 202 if an active assailant is encountered; or 3) provide additional (optional) message for other emergency situations and/or activate an alert 203; and 4) optionally view 204 details of the alert that has been sent. A wearable device may also contain a button that once pushed by the deaf or hearing-impaired individuals may automatically active the panic button module 155 directly local emergency, school, and/or law enforcement personnel to the indicated global positioning system (GPS) location.

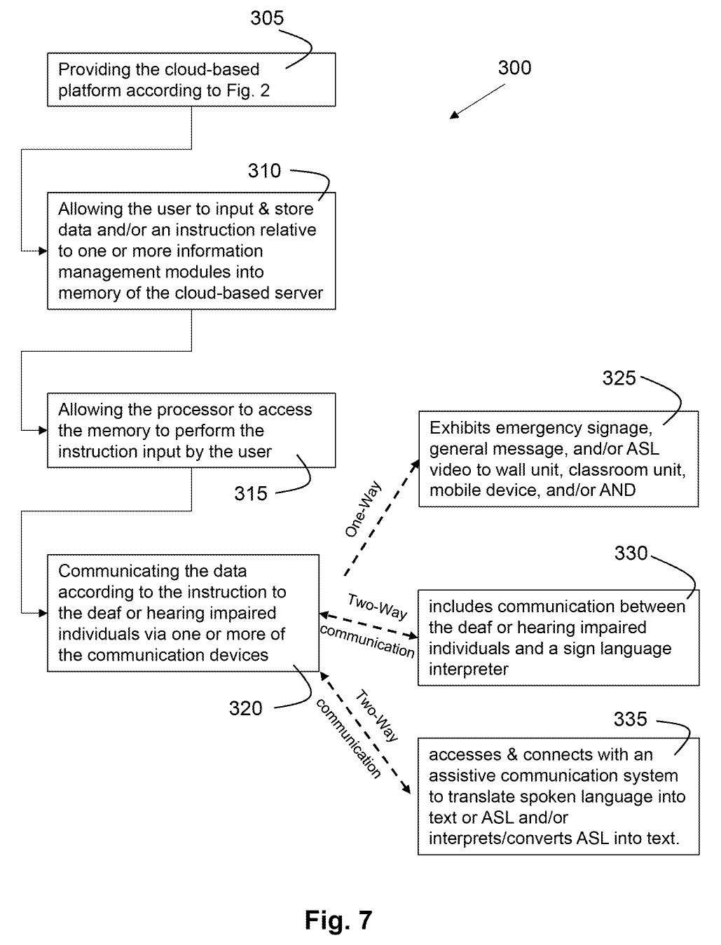

According to another aspect of the present disclosure, a method for communicating information to deaf or hearing-impaired individuals is provided. Referring now to FIG. 7, this method 300 generally comprises; providing 305 the cloud-based platform as described above and as further defined herein; allowing 310 the user to input and store data and/or an instruction into the memory of the cloud-based server, wherein the data and/or instruction is relative to one or more of the information management modules; allowing 315 the processor to access the memory and perform the instruction that has been input by the user; and communicating 320 the data according to the instruction to the deaf or hearing-impaired individuals via one or more of the communication devices.

The data may be communicated 320 to the deaf and hearing-impaired individuals by exhibiting one or more of an emergency signage, general message, or American Sign Language (ASL) video to at least one of a wall unit, a classroom unit, a mobile device, or an advanced network device (AND). The communication 320 of the data may also involve two-way communication between the deaf and hearing-impaired individuals and at least one other person. Alternatively, this two-way communication of the data may occur between the deaf or hearing-impaired individuals and a medical professional or emergency response personnel.

When desirable, the two-way communication of the data may include access to and connection with an assistive communication system that translates spoken language into text or sign language and/or interprets and converts sign language motions into text. This two-way communication of the data may also include communication between the deaf or hearing-impaired individuals and a sign language interpreter.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Those skilled-in-the-art, in light of the present disclosure, will appreciate that many changes can be made in the specific embodiments which are disclosed herein and still obtain alike or similar result without departing from or exceeding the spirit or scope of the disclosure. One skilled in the art will further understand that any properties reported herein represent properties that are routinely measured and can be obtained by multiple different methods. The methods described herein represent one such method and other methods may be utilized without exceeding the scope of the present disclosure.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A cloud-based platform for use in communicating with deaf or hearing-impaired individuals, the platform comprising:a cloud-based server having memory and at least one processor;a software system having a flexible architecture configured to interact with a user, a plurality of information management modules, and one or more communication devices; anda user interface;wherein the memory of the cloud-based server stores data and instructions received directly from the user and/or the information management modules; the stored data being provided to the deaf or hearing-impaired individuals through the one or more communication devices upon the at least one processor executing the stored instructions.

2. The cloud-based platform according to claim 1, wherein the one or more communication devices includes at least one wall unit, classroom unit, or advanced network device (AND) for use in a building or a confined area.

3. The cloud-based platform according to claim 2, wherein the wall unit, classroom unit, or AND comprises stoke or strobe lights and/or a display unit configured to exhibit one or more of emergency signage, general messages, and American Sign Language (ASL) videos.

4. The cloud-based platform according to claim 2, wherein the one or more communication devices further comprises at least one mobile device; the at least one mobile device being a cell phone, a personal digital assistant (PDA), or a tablet personal computer.

5. The cloud-based platform according to claim 3, wherein the display unit comprises a message board, a scrolling message board, or a television screen.

6. The cloud-based platform according to claim 1, wherein the cloud-based server is coupled to a telephone or internet system, such that the one or more communication devices allow for two-way communication between the deaf or hearing-impaired individuals and the user and/or the information management modules.

7. The cloud-based platform according to claim 1, wherein the information management modules comprise a content management module, and ads management module, and a device management module;wherein the content management module integrates a learning management system and a student information system with an identity management framework; the ads management module is connected with one or more broadcast networks; and the device management module includes an emergency notification/alert system.

8. The cloud-based platform according to claim 7, wherein the information management modules further comprise one or more of a telehealth or telemedicine module, a safety or wellness module, a visitor or guest management module, an incident or compliance management module, a ticketing or event management module, a tip-line module, a panic button module, an artificial intelligence (AI) predictive analysis module, and a communications suite module.

9. The cloud-based platform according to claim 8, wherein the communications suite module comprises an assistive communication system configured to translate spoken language or interpret and convert sign language motions into text shown on the one or more communication devices.

10. The cloud-based platform according to claim 8, wherein the communications suite module provides for communication between the deaf or hearing-impaired individuals and a sign language interpreter.

11. The cloud-based platform according to claim 8, wherein the communications suite module provides for communication using American Sign Language (ASL) and other sign languages.

12. The cloud-based platform according to claim 8, wherein the telehealth or telemedicine module is configured to allow communication between the deaf or hearing- impaired individuals and a medical professional.

13. The cloud-based platform according to claim 8, wherein the panic button module is configured to allow the deaf or hearing-impaired individuals to activate and send an alert to emergency personnel with GPS tracking of the communication device being enabled.

14. The cloud-based platform according to claim 1, wherein the user is a safety officer, a nurse, a teacher, a principal, or another staff member of a school or an employee of an authorized vendor or contractor.

15. A method for communicating information to deaf or hearing-impaired individuals, the method comprising the steps of: providing the cloud-based platform according to claim 1; allowing the user to input and store data and/or an instruction into the memory of the cloud-based server; the data and/or instruction being relative to one or more of the information management modules; allowing the processor to access the memory and perform the instruction that has been input by the user; and communicating the data according to the instruction to the deaf or hearing- impaired individuals via one or more of the communication devices.

16. The method according to claim 15, wherein the data is communicated by exhibiting one or more of an emergency signage, general message, or American Sign Language (ASL) video to at least one of a wall unit, a classroom unit, a mobile device, or an advanced network device (AND).

17. The method according to claim 15, wherein communication of the data involves two- way communication between the deaf and hearing-impaired individuals and at least one other person.

18. The method according to claim 17, wherein the two-way communication of the data includes access to and connection with an assistive communication system that translates spoken language into text or sign language and/or interprets and converts sign language motions into text.

19. The method according to claim 17, wherein the two-way communication of the data includes communication between the deaf or hearing-impaired individuals and a sign language interpreter.

20. The method according to claim 17, wherein the two-way communication of the data occurs between the deaf or hearing-impaired individuals and a medical professional or emergency response personnel.
